(19) United States
(12) Patent Application Publication
(10) Pub. No.: US 2025/0316269 A1
(43) Pub. Date: Oct. 9, 2025

(54) METHOD FOR PROCESSING CROSS-MODAL QUESTION ANSWERNING BASED ON LARGE MODEL, APPARATUS AND STORAGE MEDIUM

(71) Applicant: BEIJING BAIDU NETCOM SCIENCE TECHNOLOGY CO., LTD., Beijing (CN)

(72) Inventors: Xiaohui LI, Beijing (CN); Xingyuan PENG, Beijing (CN); Xiaoyin FU, Beijing (CN); Xing YU, Beijing (CN); Wuchen CHEN, Beijing (CN); Xing NIE, Beijing (CN); Yunze GAO, Beijing (CN); Letong SHI, Beijing (CN); Shijun CONG, Beijing (CN); Guibin WANG, Beijing (CN); Lei JIA, Beijing (CN)

(73) Assignee: BEIJING BAIDU NETCOM SCIENCE TECHNOLOGY CO., LTD., Beijing (CN)

(21) Appl. No.: 19/242,726

(22) Filed: Jun. 18, 2025

(30) Foreign Application Priority Data
Mar. 20, 2025 (CN) 202510336695.9

(51) Int. Cl. G10L 15/22; G10L 15/16; G10L 15/18

(52) U.S. Cl. CPC G10L 15/22; G10L 15/16; G10L 15/1815

(57) ABSTRACT

A method for processing cross-modal question answering based on large model, an apparatus, and a storage medium are suggested, which relates to the field of artificial intelligence technologies such as speech interaction processing, large models, machine learning and natural language processing. The specific implementation includes: performing an activity detection on a target speech input by a user; in response to detecting a pause in the inputting of the target speech, obtaining a first text corresponding to a first input speech before the moment of the pause in the target speech; performing a text response processing using a pre-trained speech question answering processing system based on the first text and the first input speech.

The present application claims the priority of Chinese Patent Application No. 202510336695.9, filed on Mar. 20, 2025, with the title of “METHOD FOR PROCESSING CROSS-MODAL QUESTION ANSWERNING BASED ON LARGE MODEL, APPARATUS AND STORAGE MEDIUM”. The disclosure of the above application is incorporated herein by reference in its entirety.

### FIELD OF THE DISCLOSURE

The present disclosure relates to the field of computer technology, specifically to the field of artificial intelligence technologies such as speech interaction processing, large models, machine learning and natural language processing. In particular, the present disclosure relates to a method for processing cross-modal question answering based on large model, and corresponding apparatus and storage medium.

### BACKGROUND OF THE DISCLOSURE

With the continuous advancement of technology, requirements of users for interaction experience in the field of human-computer interaction have also been increasing.

Traditional interaction methods are often limited to a single modality, such as text input or simple visual feedback, which can hardly meet diverse needs of users for information acquisition and interaction in complex scenarios. Therefore, in order to better simulate human interaction and deal with complex problems in the real world, cross-modal processing has become crucial.

### SUMMARY OF THE DISCLOSURE

The present disclosure provides a method for processing cross-modal question answering based on large model, an apparatus, and a storage medium.

According to one aspect of the present disclosure, a method for processing cross-modal question answering based on large model is, including:
performing an activity detection on a target speech input by a user;
in response to detecting a pause in the inputting of the target speech, obtaining a first text corresponding to a first input speech before the moment of the pause in the target speech;
performing a text response processing using a pre-trained speech question answering processing system based on the first text and the first input speech.

According to another aspect of the present disclosure, a method for training a speech question answering system is provided, including:
obtaining training data, the training data including a training text question, an annotated text answer, and an annotated feature representation of the training text question;
performing a speech mixing on the training text question using a pre-trained speech mixing system to obtain a training speech question;
adjusting parameters in the speech question answering system based on the training speech question, the training text question, the annotated feature representation of the training text question and the annotated text answer to obtain the trained speech question answering processing system, wherein the speech question answering system is used in the method of the above aspect and any possible implementation.

According to a further aspect of the present disclosure, there is provided an electronic device, including:
at least one processor; and
a memory communicatively connected with the at least one processor;
wherein the memory stores instructions executable by the at least one processor, and the instructions are executed by the at least one processor to enable the at least one processor to perform a method for processing cross-modal question answering based on large model, wherein the method for processing cross-modal question answering based on large model includes:
performing an activity detection on a target speech input by a user;
in response to detecting a pause in the inputting of the target speech, obtaining a first text corresponding to a first input speech before the moment of the pause in the target speech;
performing a text response processing using a pre-trained speech question answering processing system based on the first text and the first input speech.

According to a further aspect of the present disclosure, there is provided a non-transitory computer readable storage medium with computer instructions stored thereon, wherein the computer instructions are used for causing a method for processing cross-modal question answering based on large model, wherein the method for processing cross-modal question answering based on large model includes:
performing an activity detection on a target speech input by a user;
in response to detecting a pause in the inputting of the target speech, obtaining a first text corresponding to a first input speech before the moment of the pause in the target speech;
performing a text response processing using a pre-trained speech question answering processing system based on the first text and the first input speech.

It should be understood that the content described in this section is not intended to identify key or important features of the embodiments of the present disclosure, nor is it used to limit the scope of the present disclosure. Other features of the present disclosure will become readily understood through the following specification.

### BRIEF DESCRIPTION OF DRAWINGS

The drawings are used for better understanding the present solution and do not constitute a limitation of the present disclosure. In the drawings,

FIG. 1 is a schematic diagram according to the first embodiment of the present disclosure;

FIG. 2 is a schematic diagram according to the second embodiment of the present disclosure;

FIG. 3 is a schematic diagram according to the third embodiment of the present disclosure;

FIG. 4 is a schematic diagram of the architecture of a speech encoder according to embodiments of the present disclosure;

FIG. 5 is a schematic diagram according to the fourth embodiment of the present disclosure;

FIG. 6 is a schematic diagram according to the fifth embodiment of the present disclosure;

FIG. 7 is a training principle diagram of a speech question answering system according to embodiments of the present disclosure;

FIG. 8 is a schematic diagram according to the sixth embodiment of the present disclosure;

FIG. 9 is a schematic diagram according to the seventh embodiment of the present disclosure;

FIG. 10 is a schematic diagram according to the eighth embodiment of the present disclosure;

FIG. 11 is a schematic diagram according to the ninth embodiment of the present disclosure;

FIG. 12 is a block diagram of an electronic device for implementing the method according to embodiments of the present disclosure.

### DETAILED DESCRIPTION OF PREFERRED EMBODIMENTS

The following part will illustrate exemplary embodiments of the present disclosure with reference to the drawings, including various details of the embodiments of the present disclosure for a better understanding. The embodiments should be regarded only as exemplary ones. Therefore, those skilled in the art should appreciate that various changes or modifications can be made with respect to the embodiments described herein without departing from the scope and spirit of the present disclosure. Similarly, for clarity and conciseness, the descriptions of the known functions and mechanisms are omitted in the descriptions below.

Obviously, the described embodiments are only part of the embodiments of the present disclosure, not all of them. All other embodiments obtained by those skilled in the art without creative work based on the embodiments in the present disclosure fall within the protection scope of the present disclosure.

It should be noted that the terminal devices involved in the embodiments of the present disclosure may include but are not limited to mobile phones, Personal Digital Assistants (PDA), wireless handheld devices, Tablet Computers and other smart devices; display devices may include but are not limited to personal computers, televisions and other devices with display functions.

In addition, the term “and/or” in this document is merely a description of the association relationship of associated objects, indicating that three relationships may exist. For example, A and/or B may indicate: A exists alone, both A and B exist simultaneously, or B exists alone. Additionally, the character “/” in this document generally indicates an “or” relationship between the associated objects before and after it.

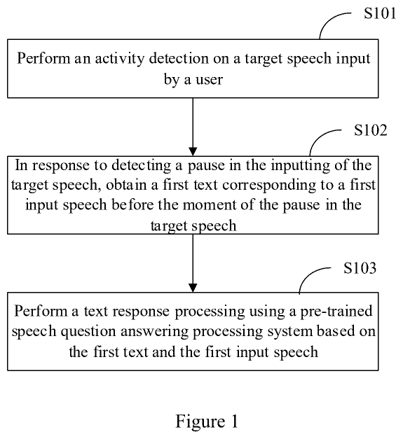

FIG. 1 is a schematic diagram according to the first embodiment of the present disclosure. As shown in FIG. 1, the present embodiment provides a method for processing cross-modal question answering based on large model, which specifically includes the following steps of:
S101: Performing an activity detection on a target speech input by a user;
S102: In response to detecting a pause in the inputting of the target speech, obtaining a first text corresponding to a first input speech before the moment of the pause in the target speech;
S103: Performing a text response processing using a pre-trained speech question answering processing system based on the first text and the first input speech.

The subject for implementing the method for processing cross-modal question answering based on large model in the present embodiment is an apparatus for processing cross-modal question answering based on large model. The apparatus can be an electronic entity or an application integrated with software.

Specifically, the activity detection is performed on the target speech input by the user, that is, detecting whether there is a speech input by the user. Since the activity detection is a process of continuously detecting the speech input by the user, a pause in the inputting of the target speech by the user can be detected through the above activity detection.

In practical applications, when a user inputs a target speech, there will be a normal breathing pause. The duration of the normal breathing pause is very short, in which case it can be considered that the user is still inputting speech rather than a pause in the inputting of the speech. However, if the duration of a pause is longer, which is greater than that of the normal breathing pause, such as reaching or exceeding a first preset duration, it can be considered that a pause in the inputting of the user has occurred. Based on this principle, the activity detection is performed on the target speech input by the user to detect whether there is a pause in the inputting of the target speech.

In the present embodiment, when a pause in the inputting of the target speech is detected, the first input speech before the moment of the pause is obtained and a speech recognition is performed on the first input speech to obtain the first text. Then, the pre-trained speech question answering processing system can be used to perform a question answering processing based on the first input speech and the first text.

The speech question answering processing system in the present embodiment can use a large model and can process cross-modal information, such as speech to text. That is, in a specific implementation, the input question is a speech and the output answer is a text response, that is, a cross-modal question answering processing which can be finally realized.

The method for processing cross-modal question answering based on large model in the present embodiment can perform question answering processing using the speech question answering processing system based on the first input speech of the user and corresponding first text when there is a pause in the inputting of the speech. Since the question input by the user is in speech modality and the text response processing is performed when responding, the technical solution according to the present embodiment can realize cross-modal question answering processing. Moreover, when performing the text response processing, the first text and the first input speech are simultaneously referred to, which can effectively improve the accuracy and efficiency of question answering processing.

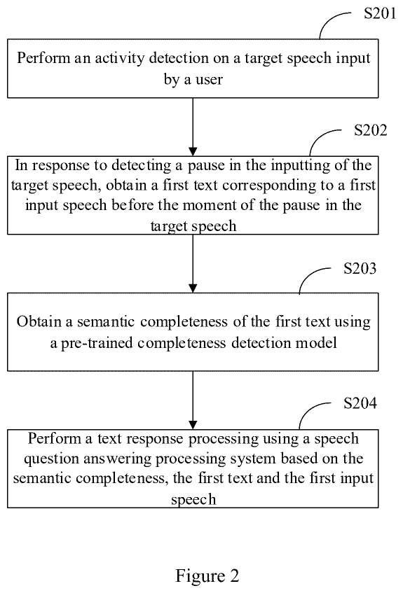

FIG. 2 is a schematic diagram according to the second embodiment of the present disclosure. The method for processing cross-modal question answering based on large model of the present embodiment further describes the technical solution of the present disclosure in more detail on the basis of the technical solution of the embodiment shown in FIG. 1. As shown in FIG. 2, the method for processing cross-modal question answering based on large model of the present embodiment specifically includes the following steps of:
S201: Performing an activity detection on a target speech input by a user;
S202: In response to detecting a pause in the inputting of the target speech, obtaining a first text corresponding to a first input speech before the moment of the pause in the target speech;
S203: Obtaining a semantic completeness of the first text using a pre-trained completeness detection model;

Specifically, the completeness detection model is used to perform semantic completeness detection on the first text to obtain the semantic completeness of the first text.

The completeness detection model is implemented based on a neural network model. When in use, the first text is input into the completeness detection model, which can predict the semantic completeness of the first text based on the first text. For example, the semantic completeness can be a value between 0 and 1. The larger the value, the more complete the semantics; Otherwise, the smaller the value, the more incomplete the semantics.

S204: Performing a text response processing using a speech question answering processing system based on the semantic completeness, the first text and the first input speech.

For example, when the step S204 is specifically implemented, it may include the following steps of:

(1) Obtaining a feature representation of the first input speech by using a speech encoder in the speech question answering processing system based on the first input speech and the first text, wherein the length of the feature representation is equal to the length of the first text;

In the present embodiment, the feature representation encoded by the speech encoder by encoding the first input speech with reference to the first text is finally in the form of a matrix, and the length of the matrix can be considered as the length of the feature representation of the first input speech. In the present embodiment, the speech encoder needs to refer to the first text corresponding to the first input speech when encoding the first input speech, so the length of the feature representation of the first input speech is equal to the length of the first text. That is, the obtained feature representation of the first input speech is a unified acoustic representation of the same length as the first text.

Commonly used speech encoders in the industry generally use an encoder structure, which can process an input audio and extract the hidden layer representation of an audio frame granularity. Since it is the representation of the audio frame granularity, its granularity is much smaller than that of the text token, so its sequence length is also much longer than that of the text sequence length, which will bring many difficulties to modal alignment. The speech encoder of the present embodiment can adopt an encoder-decoder structure to perform a historical abstraction on the output of the encoder based on the output of the decoder, and finally obtain an equal-length acoustic unified representation of the text token granularity. Modal alignment based on the equal-length acoustic unified representation is easier, and the model inference speed is also faster.

(2) Performing a text response processing using a cross attention large language model (LLM) in the speech question answering processing system based on the semantic completeness and the feature representation of the first input speech.

Specifically, when step (2) is implemented, it may include the following steps of:

(a1): detecting whether the semantic completeness of the first input speech is less than a preset completeness; if yes, executing step (b1); if no, executing step (d1);

In the present embodiment, if the semantic completeness is greater than or equal to the preset completeness, the semantics of the first input speech is considered complete; otherwise, if the semantic completeness is less than the preset completeness, the semantics is considered incomplete.

(b1): Generating question information using the cross attention large language model based on the feature representation of the first input speech; executing step (c1);

Optionally, the semantic completeness obtained above can also be input into the cross attention large language model, which can determine that the hesitant questioning mechanism should be triggered based on the semantic completeness and preset completeness.

Alternatively, when it is determined in step (a1) that the semantics is incomplete, question information can be directly generated as a prompt, which is directly input into the cross attention large language model together with the feature representation of the first input speech. The cross attention large language model generates question information based on the input information.

Of course, optionally, only the feature representation of the first input speech can be input into the cross attention large language model. The cross attention large language model itself is a very intelligent large language model, which can recognize that the first input speech is incomplete according to the feature representation of the first input speech and further generate question information to prompt the hesitant user to continue to complete the question. Therefore, the question information can also be called hesitant questioning information, which is used for the user to ask questions when the user is hesitant to input, so as to prompt the user to better complete the question.

(c1): Performing a text response based on the question information.

For example, when a user pauses during the speech input, the first text corresponding to the first input speech is “I want to listen”. According to the above embodiment, when it is detected that the semantics of the first text is incomplete, the question information generated by the cross attention large language model could be “Do you want to listen to music?” and respond to the user. The user can continue to input speech based on the question information to make the input speech more complete.

(d1): Generating a first text answer based on the feature representation of the first input speech using the cross attention large language model; executing step (e1);

(e1): Storing the feature representation of the first input speech and the first text answer in a cache.

At this time, since the premise of the detection is a pause in the inputting rather than a speech termination, if a direct response is made based on the generated first text answer, not only will there be undesirable phenomena such as interrupting the conversation, but also, since the inputting of the speech of the user does not stopped, the first text answer generated may not be the result the user wants. Therefore, at this time, the feature representation of the first input speech and the first text answer are stored in the cache without immediate response. If the inputting of the speech of the user ends later and the user does not add other speech inputs, a quick response can be made directly based on the first text answer, thereby improving the efficiency of question answering processing.

The cross-modal question answering processing method based on large model in the present embodiment performs text response processing using the speech question answering processing system based on the semantic completeness, the first text and the first input speech, which can effectively improve the accuracy of question answering processing.

Moreover, in the present embodiment, the speech encoder in the speech question answering processing system can perform speech encoding based on the first input speech and the first text to obtain the feature representation of the first input speech, so that the length of the feature expression of the first input speech is the same as the length of the first text. In this way, when the cross attention LLM in the speech question answering processing system later performs text response processing, the length of the feature expression of the first input speech is the same as the length of the first text, which can reduce the difficulty of modal alignment between different modal information in the text response process, and further effectively speed up the model inference speed.

Furthermore, in the present embodiment, when the semantics is incomplete, question information can be generated to further assist users in completing the inputting of the speech. When the semantics is complete, a text answer can be generated timely and stored in a cache, so that when the subsequent speech ends, a direct response can be made, which effectively shortens the response time and can effectively improve the efficiency of the question answering processing.

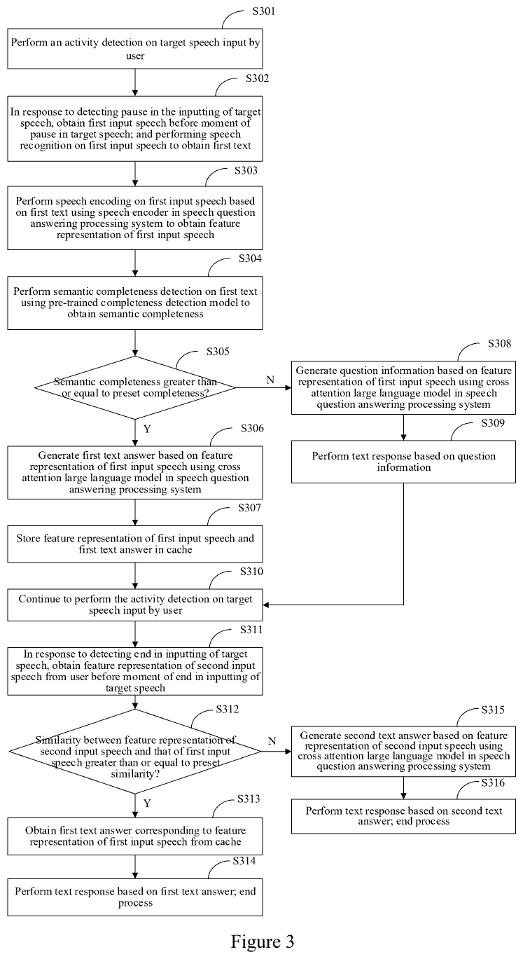

FIG. 3 is a schematic diagram according to a third embodiment of the present disclosure. The method for processing cross-modal question answering based on large model of the present embodiment further describes the technical solution of the present disclosure in more detail on the basis of the technical solution of the embodiment shown in FIG. 2. As shown in FIG. 3, the method for processing cross-modal question answering based on large model of the present embodiment specifically includes the following steps of:
S301: Performing an activity detection on a target speech input by a user;
S302: In response to detecting a pause in the inputting of the target speech, obtaining a first input speech before the moment of the pause in the target speech; and performing a speech recognition on the first input speech to obtain a first text;
S303: Performing a speech encoding on the first input speech based on the first text using a speech encoder in the speech question answering processing system to obtain a feature representation of the first input speech;

In the present embodiment, the length of the feature representation of the first input speech is equal to the length of the first text.

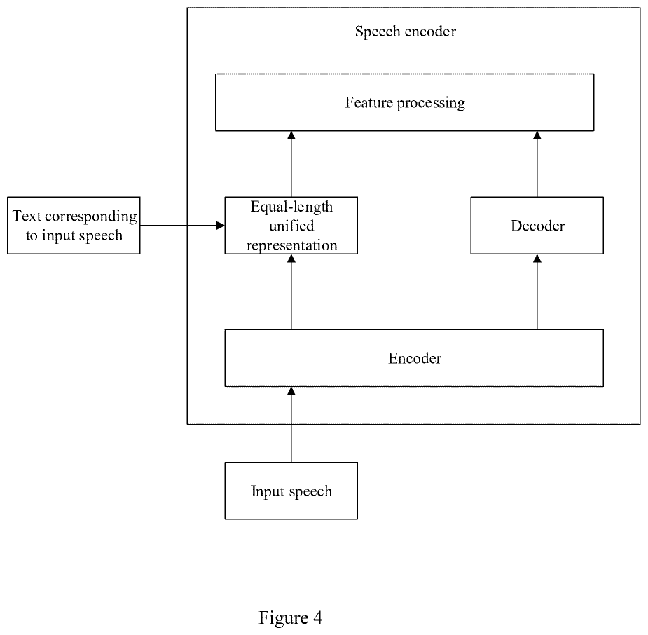

For example, FIG. 4 is a schematic diagram of the architecture of a speech encoder according to embodiments of the present disclosure. As shown in FIG. 4, the speech encoder of the present embodiment adopts an encoder-decoder structure. For example, the encoder can use a streaming multi-Layer truncated attention (SMLTA) encoder, and the corresponding decoder can adopt an SMLTA decoder. The equal-length unified representation is to the features of the input speech into features of the same length as the text of the input speech based on the text of the input speech. Then the feature fusion processing is performed based on the features of the equal-length unified representation and the features decoded by the decoder to obtain the final feature expression of the same length as the text corresponding to the input speech. During the processing, the speech and its corresponding text are directly input into the speech encoder, which can use the architecture shown in FIG. 4 to output a feature expression of the input speech of the same length as the text.
S304: Performing a semantic completeness detection on the first text using a pre-trained completeness detection model to obtain a semantic completeness;
S305: Detecting whether the semantic completeness is greater than or equal to the preset completeness; if greater than or equal to, determining that the semantics is complete and performing step S306; otherwise, determining that the semantics is incomplete and executing step S308;
S306: Generating a first text answer based on the feature representation of the first input speech using the cross attention large language model in the speech question answering processing system; executing step S307;

In the present embodiment, the input to the cross attention large language model can be in the form of key-value pairs (key, Value), where the values of the “key” and the “Value” are both feature expressions of the first input speech.

S307: Storing the feature representation of the first input speech and the first text answer in the cache; executing step S310;

The feature representation of the first input speech and the first text answer can also be stored in key-Value form. The pre-storage function that is implemented in steps S306-S307 is to store the first text answer and the corresponding feature expression of the first input speech in the cache in advance, so as to facilitate a quick response later.

S308: Generating question information based on the feature representation of the first input speech using the cross attention large language model in the speech question answering processing system; executing step S309;

S309: Performing a text response based on the question information; executing step S310;

The generation of question information and corresponding question answering response of the present embodiment belongs to an active questioning mechanism, which can effectively assist a user in completing the inputting of the speech by the user more proactively and smoothly.

S310: Continuing to perform the activity detection on the target speech input by the user; executing step S311;

S311: In response to detecting an end in the inputting of the target speech, obtaining a feature representation of a second input speech from the user before the moment of the end in the inputting of the target speech;

In the present embodiment, during the activity detection of the target speech input by the user, detecting a pause in the inputting of speech specifically refers to detecting that the duration of stopped inputting of the speech reaches a first preset duration, at which point it is determined that there is a pause in the inputting of the speech by the user. Detecting an end in the inputting of speech specifically refers to detecting that the duration of stopped speech input reaches a second preset duration; the second preset duration is greater than the first preset duration.

In other words, during the process of the user for inputting the speech, first a pause in the inputting of speech is detected. If the user does not input further speech, the end in the inputting of speech can then be detected. The lengths of the first preset duration and second preset duration can be set according to actual scenarios and are not limited here.

For example, when this step is implemented specifically, it may include the following steps of:

(a2) In response to detecting the end in the inputting of speech, obtaining the second input speech from the user before the moment of the end in the inputting of the target speech;

In combination with the above scenario, the second input speech of the present embodiment can include only the first input speech; or it can include the first input speech and other speech subsequently supplemented by the user.

(b2) Performing a speech recognition on the second input speech to obtain a second text;

(c2) Obtaining a feature representation of the second input speech using the speech encoder in the speech question answering processing system based on the second input speech and the second text, so that the length of the feature expression of the second input speech is equal to the length of the second text.

The implementation methods of steps (a2)-(c2) is the same as those of the above steps S302-S303.

S312: Detecting whether the similarity between the feature representation of the second input speech and the feature representation of the first input speech in the cache is greater than or equal to a preset similarity; if yes, executing step S313; otherwise, executing step S315;

S313: Obtaining the first text answer corresponding to the feature representation of the first input speech from the cache; executing step S314;

S314: Performing a text response based on the first text answer; ending the process;

In step S313, obtaining from the cache the text answer pre-stored in steps S306-S307, may be a pre-fetching function, and the two are combined to realize the pre-storage and pre-fetching functions of the embodiment of the present disclosure.

S315: Generating a second text answer based on the feature representation of the second input speech using the cross attention large language model in the speech question answering processing system; executing step S316;

S316: Performing a text response based on the second text answer; ending the process.

Specifically, in actual application scenarios, since the second preset duration is longer than the first preset duration, a pause in the inputting of speech by the user will necessarily be detected before detecting an end in the inputting of speech. That is, a pause in the input must occur before the end of the inputting of the speech by the user. Therefore, in normal scenarios, the above-mentioned pre-storage and pre-fetching functions of the present embodiment are adopted to achieve fast response.

For the sake of completeness of the scheme, in order to avoid the situation where the correct feature expression of the first input speech and the corresponding first text answer are not stored in the cache, when the similarity between the feature representation of the second input speech and the feature representation of the first input speech in the cache does not reach the preset similarity threshold, a cross attention large language model can also be used to generate a second text answer based on the feature representation of the second input speech; and a question and answer response is performed to ensure the accuracy of the question and answer.

The speech question answering processing system using a speech encoder and a cross attention large language model of the present embodiment is an end-to-end model, which can avoid the high latency caused by the serial processing of the traditional cascade solution and the performance degradation caused by error propagation, and effectively improve the efficiency of question-answering processing.

Moreover, in the present embodiment, it is possible to detect the pause in the inputting of the speech at the audio frame level, based on which semantic integrity judgment and active questioning mechanisms are triggered, thereby assisting the user to complete the interaction more actively and smoothly.

Moreover, in the present embodiment, when the speech pauses and the semantics is complete, the cross attention large language model response can be triggered, and the response is cached to complete the pre-storage operation. When the speech ends, the corresponding response is queried from the cache through the pre-fetch mechanism, thereby reducing the system response delay, thereby achieving a faster and lower-latency interactive experience, and effectively improving the efficiency of question answering processing.

In summary, with the above technical solution, the method for processing cross-modal question answering based on large model according to the present embodiment can achieve faster, more accurate, richer, and more proactive and smooth interaction experience.

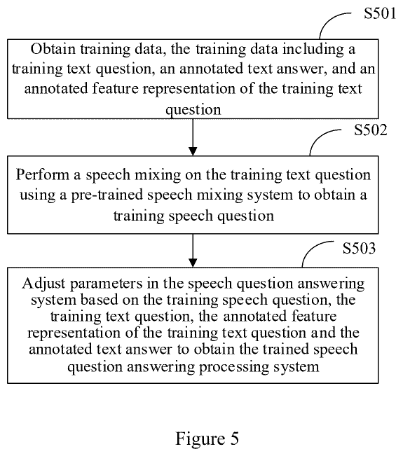

FIG. 5 is a schematic diagram according to a fourth embodiment of the present disclosure. As shown in FIG. 5, the present embodiment provides a method for training a speech question answering system, specifically including the following steps of:

S501: Obtaining training data, the training data including a training text question, an annotated text answer, and an annotated feature representation of the training text question;

In the present embodiment, the annotated text answer refers to the answer corresponding to the training text question. The annotated feature representation of the training text question can be vectorized using a pre-trained feature representation model. For example, the annotated feature expression of the training text question can also be obtained by encoding the training text question using a One-Hot encoding method to obtain a vector representation.

S502: Performing a speech mixing on the training text question using a pre-trained speech mixing system to obtain a training speech question;

In order to realize the cross-modal information processing of speech question answering, in actual application scenarios, collecting text information is much easier than collecting speech information. Therefore, in the present embodiment, when collecting training samples, the text question and the annotated text answer are collected. Then a pre-trained speech mixing system can be used to mix the training text to generate the training speech question.

In practical applications, other traditional speech mixing techniques can also be used to perform the speech mixing on the training text question to obtain the training speech question.

S503: Adjusting parameters in the speech question answering system based on the training speech question, the training text question, the annotated feature representation of the training text question and the annotated text answer to obtain the trained speech question answering processing system.

The subject for implementing the method for training the speech question answering system of the present embodiment can be an apparatus for training the speech question answering system, which can be an electronic entity or a software-integrated application.

The speech question answering system trained in the present embodiment is the speech question answering system of any of the embodiments shown in FIGS. 1-3.

In the present embodiment, the training speech question and the training text can serve as input data, and the annotated feature representation of the training text question and the annotated text answer can serve as supervision data. Based on the training speech question, the training text question, the annotated feature representation of the training text question and the annotated text answer, the parameters in the speech question answering system can be adjusted to achieve the training of the speech question answering system.

With the above method, the method for training the speech question answering system of the present embodiment can realize end-to-end training of the speech question answering system, and effectively improve the accuracy of the trained speech question answering system.

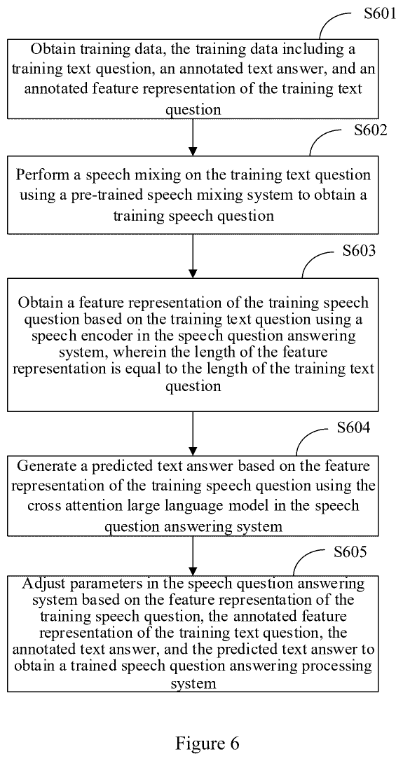

FIG. 6 is a schematic diagram according to the fifth embodiment of the present disclosure. The method for training a speech question answering system of the present embodiment further describes the technical solution of the present disclosure in more detail on the basis of the technical solution of the embodiment shown in FIG. 5. As shown in FIG. 6, the method for training a speech question answering system of the present embodiment specifically includes the following steps of:
S601: Obtaining training data, the training data including a training text question, an annotated text answer, and an annotated feature representation of the training text question;
S602: Performing a speech mixing on the training text question using a pre-trained speech mixing system to obtain a training speech question;
The speech mixing system of the present embodiment can be modeled based on a large amount of network audio and video data, user-authorized online real data, and training data of the speech synthesis system to achieve the ability to generate speech spectrum from text. The system can accurately generate the speech spectrum corresponding to the input text, and can accurately and flexibly control speech-related attributes such as timbre, rhythm, emotion, and acoustic environment to generate diversified audio data covering real scenes.

Based on the speech mixing system, audio input requests can be mass-produced, thereby solving the problem of large-scale annotated audio text data required for cross-modal model training.

S603: Obtaining a feature representation of the training speech question based on the training text question using a speech encoder in the speech question answering system, wherein the length of the feature representation is equal to the length of the training text question;

The method for implementing step S603 is the same as the encoding principle of the speech encoder in the embodiment shown in FIG. 2 or FIG. 3, and will not be repeated here.

S604: Generating a predicted text answer based on the feature representation of the training speech question using the cross attention large language model in the speech question answering system;

S605: Adjusting parameters in the speech question answering system based on the feature representation of the training speech question, the annotated feature representation of the training text question, the annotated text answer, and the predicted text answer to obtain a trained speech question answering processing system.

For example, when this step is implemented specifically, it may include the following steps of:
(a3) Constructing a first loss function (Loss1) based on the feature representation of the training speech question and the annotated feature representation of the training text question;
(b3) Constructing a second loss function (Loss2) based on the annotated text answer and the predicted text answer;
(c3) Adjusting parameters of the speech encoder and the cross attention large language model based on Loss1 and Loss2 to obtain the trained speech question answering processing system.

For example, the sum of the first loss function and the second loss function can be taken as the integrated loss function;
Based on the integrated loss function, the parameters of the speech encoder and the cross-attention large language model are adjusted so that the integrated loss function converges.

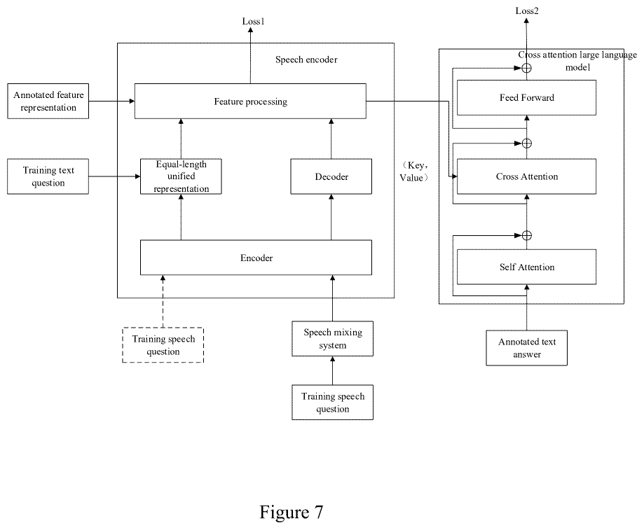

For example, FIG. 7 is a training principle diagram of a speech question answering system according to embodiments of the present disclosure. As shown in FIG. 7, the speech question answering system including the speech encoder and cross attention large language model is an end-to-end model. During training, the above-mentioned technical scheme of the present embodiment is adopted to train the speech encoder and the cross-attention large language model together, which can avoid the high delay caused by the serial processing of the traditional cascade scheme and the performance degradation caused by error propagation, so that the trained speech question answering system has higher accuracy.

It should be noted that, considering the scarcity of existing high-quality speech question answering data, the above technical solution of the present embodiment takes the use of a speech mixing system to construct training speech data as an example. In actual application scenarios, training data can also be constructed based on high-quality speech question answering data. In this case, each piece of training data includes: a training speech question, an annotated text answer, and an annotated feature expression of the training text question corresponding to the training speech question; the training text question is obtained by performing speech recognition on the training speech question. The annotated feature expression of the training text question is obtained in the same manner as in the above embodiment. For example, the training text question can be encoded using One-Hot encoding to obtain a vector representation. The speech question answering system is trained using the above S603-S605. In actual application scenarios, the training data constructed using the above two methods of the present embodiment can be used together to train the speech question answering system.

In the present embodiment, a large amount of text question and answer data can be subjected to a speech mixing to generate a large amount of speech question answering data, and are mixed with real speech data for end-to-end training, which greatly reduces the demand for speech question answering data and can solve the problem that the commonly used solutions in the industry rely heavily on high-quality speech question answering data.

In the present embodiment, dual-loss training can also be used. Loss1 constrains the parameters of the speech encoder so that it retains a certain text space capability. At the same time, the hidden features of the speech encoder are input into the cross attention large language model, so that the cross attention large language model can integrate other information outside the text, such as emotion, paralanguage, speaker, etc., make comprehensive decisions, and provide rich responses.

With the above method, the method for training the speech question answering system of the present embodiment can realize an end-to-end training, and effectively improve the accuracy of the obtained speech question answering system by the training.

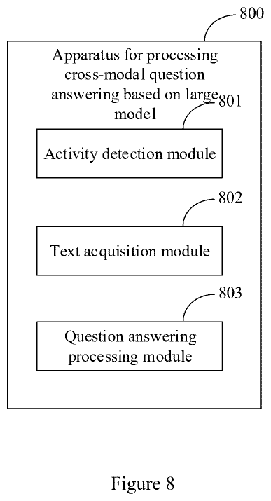

FIG. 8 is a schematic diagram according to the sixth embodiment of the present disclosure. As shown in FIG. 8, the present embodiment provides an apparatus 800 for processing cross-modal question answering based on large model, including:
an activity detection module 801 configured to perform an activity detection on a target speech input by a user;
a text acquisition module 802 configured to, in response to detecting a pause in the inputting of the target speech, obtain a first text corresponding to a first input speech before the moment of the pause in the target speech;
a question answering processing module 803 configured to perform a text response processing using a pre-trained speech question answering processing system based on the first text and the first input speech.

By adopting the above-mentioned modules to implement the method for processing cross-modal question answering based on large model, the implementation principle and technical effects of apparatus 800 for processing cross-modal question answering based on large model of the present embodiment are the same as those of embodiments of the above-mentioned related method. For details, please refer to the description to embodiments of the above-mentioned related method, which will not be repeated here.

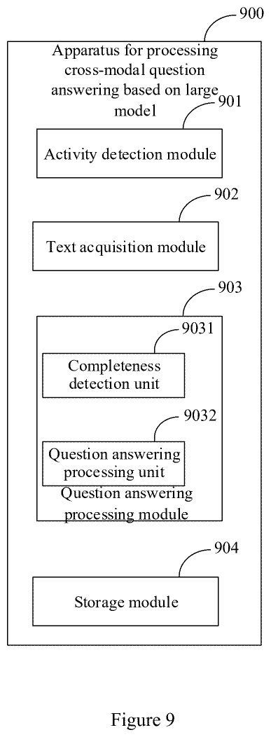

FIG. 9 is a schematic diagram according to the seventh embodiment of the present disclosure. The present embodiment provides a more detailed description of the technical solution based on the embodiment shown in FIG. 8. As shown in FIG. 9, an apparatus 900 for processing cross-modal question answering based on large model includes modules with the same names and functions as in FIG. 8: an activity detection module 901, a text acquisition module 902, and a question answering processing module 903.

As shown in FIG. 9, in the present embodiment, the question answering processing module 903 includes:
a completeness detection unit 9031 configured to obtain a semantic completeness of the first text using a pre-trained completeness detection model;
a question answering processing unit 9032 configured to perform a text response processing using a speech question answering processing system based on the semantic completeness, the first text and the first input speech.

Optionally, in one embodiment of the present disclosure, the question answering processing unit 9032 is configured to:
obtain a feature representation of the first input speech by using a speech encoder in the speech question answering processing system based on the first input speech and the first text, wherein the length of the feature representation is equal to the length of the first text;
perform a text response processing using a cross attention large language model in the speech question answering processing system based on the semantic completeness and the feature representation of the first input speech.

Optionally, in one embodiment of the present disclosure, the question answering processing unit 9032 is configured to:
generate question information based on the feature representation of the first input speech using the cross attention large language model in response to determining that the semantic completeness is less than a preset completeness;
perform a text response based on the questioning information.

Optionally, in one embodiment of the present disclosure, the question answering processing unit 9032 is configured to:
generate a first text answer based on the feature representation of the first input speech using the cross attention large language model in response to determining that the semantic completeness is greater than or equal to preset completeness; and perform a text response based on the first text answer.

Optionally, as shown in FIG. 9, the apparatus 900 for processing cross-modal question answering based on large model further includes:
a storage module 904 configured to store the feature representation of the first input speech and the first text answer in a cache.

Optionally, in one embodiment of the present disclosure, the activity detection module 901 is further configured to continue to perform the activity detection on the target speech input by the user.

The question answering processing unit 9032 is further configured to:
in response to detecting an end in the inputting of the target speech, obtain a feature representation of a second input speech from the user before the moment of the end in the inputting of the target speech;
in response to determining that the similarity between the feature representation of the second input speech and the feature representation of the first input speech in the cache is greater than or equal to a preset similarity, obtain the first text answer corresponding to the feature representation of the first input speech from the cache;
perform a text response based on the first text answer.

Optionally, in one embodiment of the present disclosure, the question answering processing unit 9032 is configured to:
in response to detecting the end in the inputting of speech, obtain the second input speech from the user before the moment of the end in the inputting of the target speech;
perform a speech recognition on the second input speech to obtain a second text;
obtain a feature representation of the second input speech using the speech encoder in the speech question answering processing system based on the second input speech and the second text, wherein the length of the feature expression of the second input speech is equal to the length of the second text.

Optionally, in one embodiment of the present disclosure, detecting the pause in the inputting of the target speech includes: detecting that the duration from the moment of the pause in the inputting of the speech reaches a first preset duration;
detecting the stop in the inputting of the target speech includes: detecting that the duration from the moment of the stop in the inputting of the speech reaches a second preset duration; where the second preset duration is greater than the first preset duration.

By adopting the above-mentioned modules to implement the method for processing cross-modal question answering based on large model, the implementation principle and technical effects of apparatus 900 for processing cross-modal question answering based on large model of the present embodiment are the same as those of embodiments of the above-mentioned related method. For details, please refer to the description to embodiments of the above-mentioned related method, which will not be repeated here.

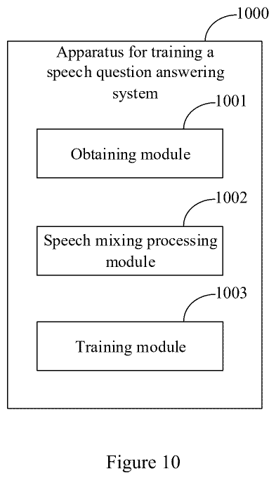

FIG. 10 is a schematic diagram according to the eighth embodiment of the present disclosure. The present embodiment provides an apparatus 1000 for training a speech question answering system, which is the speech question answering system described in the embodiments shown in FIG. 8 or FIG. 9, specifically including:
an obtaining module 1001 configured to obtain training data, the training data including a training text question, an annotated text answer, and an annotated feature representation of the training text question;
a speech mixing processing module 1002 configured to perform a speech mixing on the training text question using a pre-trained speech mixing system to obtain a training speech question;
a training module 1003 configured to adjust parameters in the speech question answering system based on the training speech question, the training text question, the annotated feature representation of the training text question and the annotated text answer to obtain the trained speech question answering processing system.

The speech question answering system of the present embodiment is used in the cross-modal question answering processing apparatus based on large model shown in FIG. 8 or FIG. 9.

By adopting the above-mentioned modules to implement the method for training a speech question answering system, the implementation principle and technical effects of apparatus 1000 for training a speech question answering system are the same as those of embodiments of the above-mentioned related method. For details, please refer to the description to embodiments of the above-mentioned related method, which will not be repeated here.

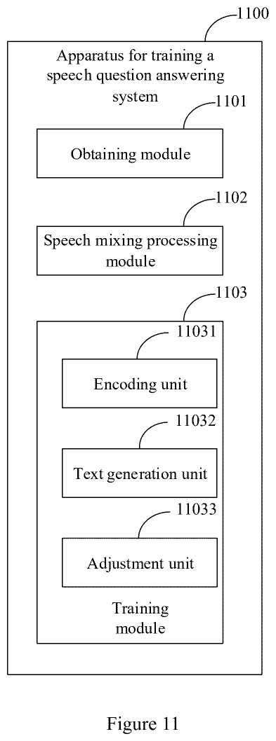

FIG. 11 is a schematic diagram according to the ninth embodiment of the present disclosure. The present embodiment provides a more detailed description of the technical solution based on the embodiment shown in FIG. 10. As shown in FIG. 11, an apparatus 1100 for training a speech question answering system includes modules with the same names and functions as in FIG. 10: an obtaining module 1101, a speech mixing processing module 1102, and a training module 1103.

As shown in FIG. 11, in the present embodiment, the training module 1103 includes:
an encoding unit 11031 configured to obtain a feature representation of the training speech question based on the training text question using a speech encoder in the speech question answering system, wherein the length of the feature representation is equal to the length of the training text question;
a text generation unit 11032 configured to generate a predicted text answer based on the feature representation of the training speech question using the cross attention large language model in the speech question answering system;
an adjustment unit 11033 configured to adjust parameters in the speech question answering system based on the feature representation of the training speech question, the annotated feature representation of the training text question, the annotated text answer, and the predicted text answer to obtain a trained speech question answering processing system.

Optionally, in one embodiment of the present disclosure, the adjustment unit 11033 is configured to:
construct a first loss function based on the feature representation of the training speech question and the annotated feature representation of the training text question;
construct a second loss function based on the annotated text answer and the predicted text answer;
adjust parameters of the speech encoder and the cross attention large language model based on the first loss function and the second loss function to obtain the trained speech question answering processing system.

Optionally, in one embodiment of the present disclosure, the adjustment unit 11033 is configured to:
take the sum of the first loss function and the second loss function as the integrated loss function;
adjust the parameters of the speech encoder and the cross-attention large language model so that the integrated loss function converges based on the integrated loss function.

By adopting the above-mentioned modules to implement the method for training a speech question answering system, the implementation principle and technical effects of apparatus 1100 for training a speech question answering system are the same as those of embodiments of the above-mentioned related method. For details, please refer to the description to embodiments of the above-mentioned related method, which will not be repeated here.

In the technical solutions of the present disclosure, the acquisition, storage and application of user personal information comply with relevant laws and regulations and do not violate public order and good morals.

According to embodiments of the present disclosure, an electronic device, a readable storage medium and a computer program product are also provided.

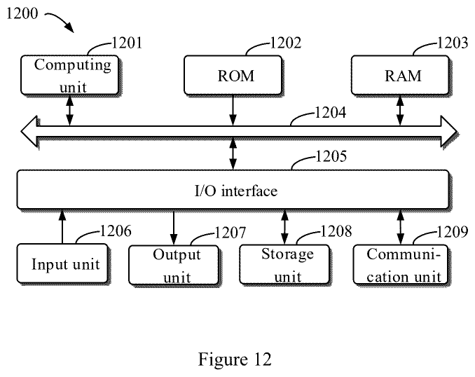

FIG. 12 is a block diagram of an electronic device for the method for parallel processing of model according to the embodiment of the present disclosure. The electronic device is intended to represent various forms of digital computers, such as laptop computers, desktop computers, workstations, personal digital assistants, servers, blade servers, mainframe computers, and other appropriate computers. The electronic device may also represent various forms of mobile apparatuses, such as personal digital assistants, cellular telephones, smart phones, wearable devices, and other similar computing apparatuses. The components shown herein, their connections and relationships, and their functions, are meant to be exemplary only, and are not meant to limit implementation of the present disclosure described and/or claimed herein.

As shown in FIG. 12, the device 1200 includes a computing unit 1201 which may perform various appropriate actions and processing operations according to a computer program stored in a read only memory (ROM) 1202 or a computer program loaded from a storage unit 1208 into a random access memory (RAM) 1203. Various programs and data necessary for the operation of the device 1200 may be also stored in the RAM 1203. The computing unit 1201, the ROM 1202, and the RAM 1203 are connected with one other through a bus 1204. An input/output (I/O) interface 1205 is also connected to the bus 1204.

The plural components in the device 1200 are connected to the I/O interface 1205, and include: an input unit 1206, such as a keyboard, a mouse, or the like; an output unit 1207, such as various types of displays, speakers, or the like; the storage unit 1208, such as a magnetic disk, an optical disk, or the like; and a communication unit 1209, such as a network card, a modem, a wireless communication transceiver, or the like. The communication unit 1209 allows the device 1200 to exchange information/data with other devices through a computer network, such as the Internet, and/or various telecommunication networks.

The computing unit 1201 may be a variety of general and/or special purpose processing components with processing and computing capabilities. Some examples of the computing unit 1201 include, but are not limited to, a central processing unit (CPU), a graphic processing unit (GPU), various dedicated artificial intelligence (AI) computing chips, various computing units running machine learning model algorithms, a digital signal processor (DSP), and any suitable processor, controller, microcontroller, or the like. The computing unit 1201 performs the methods and processing operations described above, such as the method for training a question solving model or the question solving method. For example, in some embodiments, the method for training a question solving model or the question solving method may be implemented as a computer software program tangibly included in a machine readable medium, such as the storage unit 1208.

In some embodiments, part or all of the computer program may be loaded and/or installed into the device 1200 via the ROM 1202 and/or the communication unit 1209. When the computer program is loaded into the RAM 1203 and executed by the computing unit 1201, one or more steps of the method for training a question solving model or the question solving method described above may be performed. Alternatively, in other embodiments, the computing unit 1201 may be configured to perform the method for training a question solving model or the question solving method by any other suitable means (for example, by means of firmware).

Various implementations of the systems and technologies described herein may be implemented in digital electronic circuitry, integrated circuitry, field programmable gate arrays (FPGA), application specific integrated circuits (ASIC), application specific standard products (ASSP), systems on chips (SOC), complex programmable logic devices (CPLD), computer hardware, firmware, software, and/or combinations thereof. The systems and technologies may be implemented in one or more computer programs which are executable and/or interpretable on a programmable system including at least one programmable processor, and the programmable processor may be special or general, and may receive data and instructions from, and transmit data and instructions to, a storage system, at least one input apparatus, and at least one output apparatus.

Program codes for implementing the method according to the present disclosure may be written in any combination of one or more programming languages. These program codes may be provided for a processor or a controller of a general purpose computer, a special purpose computer, or training apparatuses of other programmable vehicle positioning or positioning models, such that the program code, when executed by the processor or the controller, causes functions/operations specified in the flowchart and/or the block diagram to be implemented. The program code may be executed entirely on a machine, partly on a machine, partly on a machine as a stand-alone software package and partly on a remote machine, or entirely on a remote machine or a server.

In the context of the present disclosure, the machine readable medium may be a tangible medium which may include or store a program for use by or in connection with an instruction execution system, apparatus, or device. The machine readable medium may be a machine readable signal medium or a machine readable storage medium. The machine readable medium may include, but is not limited to, an electronic, magnetic, optical, electromagnetic, infrared, or semiconductor system, apparatus, or device, or any suitable combination of the foregoing. More specific examples of the machine readable storage medium may include an electrical connection based on one or more wires, a portable computer disk, a hard disk, a random access memory (RAM), a read only memory (ROM), an erasable programmable read only memory (EPROM or flash memory), an optical fiber, a portable compact disc read only memory (CD-ROM), an optical storage device, a magnetic storage device, or any suitable combination of the foregoing.

To provide interaction with a user, the systems and technologies described here may be implemented on a computer having: a display apparatus (for example, a cathode ray tube (CRT) or liquid crystal display (LCD) monitor) for displaying information to a user; and a keyboard and a pointing apparatus (for example, a mouse or a trackball) by which a user may provide input for the computer. Other kinds of apparatuses may also be used to provide interaction with a user; for example, feedback provided for a user may be any form of sensory feedback (for example, visual feedback, auditory feedback, or tactile feedback); and input from a user may be received in any form (including acoustic, speech or tactile input).

The systems and technologies described here may be implemented in a computing system (for example, as a data server) which includes a back-end component, or a computing system (for example, an application server) which includes a middleware component, or a computing system (for example, a user computer having a graphical user interface or a web browser through which a user may interact with an implementation of the systems and technologies described here) which includes a front-end component, or a computing system which includes any combination of such back-end, middleware, or front-end components. The components of the system may be interconnected through any form or medium of digital data communication (for example, a communication network). Examples of the communication network include: a local area network (LAN), a wide area network (WAN) and the Internet.

A computer system may include a client and a server. Generally, the client and the server are remote from each other and interact through the communication network. The relationship between the client and the server is generated by virtue of computer programs which run on respective computers and have a client-server relationship to each other. The server may be a cloud server, also called a cloud computing server or a cloud host, and is a host product in a cloud computing service system, so as to overcome the defects of high management difficulty and weak service expansibility in conventional physical host and virtual private server (VPS) service. The server may also be a server of a distributed system, or a server incorporating a blockchain.

It should be understood that various forms of the flows shown above may be used and reordered, and steps may be added or deleted. For example, the steps described in the present disclosure may be executed in parallel, sequentially, or in different orders, which is not limited herein as long as the desired results of the technical solution disclosed in the present disclosure may be achieved.

The above-mentioned implementations are not intended to limit the scope of the present disclosure. It should be understood by those skilled in the art that various modifications, combinations, sub-combinations and substitutions may be made, depending on design requirements and other factors. Any modification, equivalent substitution and improvement made within the spirit and principle of the present disclosure all should be included in the extent of protection of the present disclosure.

What is claimed is:

1. A method for processing cross-modal question answering based on large model, comprising:
performing an activity detection on a target speech input by a user;
in response to detecting a pause in the inputting of the target speech, obtaining a first text corresponding to a first input speech before the moment of the pause in the target speech;
performing a text response processing using a pre-trained speech question answering processing system based on the first text and the first input speech.

2. The method according to claim 1, wherein performing the text response processing using the pre-trained speech question answering processing system based on the first text and the first input speech comprises:
obtaining a semantic completeness of the first text using a pre-trained completeness detection model;
performing a text response processing using the speech question answering processing system based on the semantic completeness, the first text and the first input speech.

3. The method according to claim 2, wherein performing the text response processing using the speech question answering processing system based on the semantic completeness, the first text and the first input speech comprises:
obtaining a feature representation of the first input speech by using a speech encoder in the speech question answering processing system based on the first input speech and the first text, wherein the length of the feature representation is equal to the length of the first text;
performing a text response processing using a cross attention large language model in the speech question answering processing system based on the semantic completeness and the feature representation of the first input speech.

4. The method according to claim 3, wherein performing the text response processing using the cross attention large language model in the speech question answering processing system based on the semantic completeness and the feature representation of the first input speech comprises:
in response to determining that the semantic completeness is less than a preset completeness, generating question information based on the feature representation of the first input speech using the cross attention large language model;
performing a text response based on the questioning information.

5. The method according to claim 3, wherein performing the text response processing using the cross attention large language model in the speech question answering processing system based on the semantic completeness and the feature representation of the first input speech comprises:
in response to determining that the semantic completeness is greater than or equal to preset completeness, generating a first text answer based on the feature representation of the first input speech using the cross attention large language model; and performing a text response based on the first text answer.

6. The method according to claim 5, wherein after generating the first text answer based on the feature representation of the first input speech using the cross attention large language model, the method further comprises:
storing the feature representation of the first input speech and the first text answer in a cache.

7. The method according to claim 6, wherein the method further comprises:
in response to detecting an end in the inputting of the target speech, obtaining a feature representation of a second input speech from the user before the moment of the end in the inputting of the target speech;
in response to determining that the similarity between the feature representation of the second input speech and the feature representation of the first input speech in the cache is greater than or equal to a preset similarity, obtaining the first text answer corresponding to the feature representation of the first input speech from the cache;
performing a text response based on the first text answer.

8. The method according to claim 7, wherein obtaining a feature representation of a second input speech from the user before the moment of the end in the inputting of the target speech in response to detecting an end in the inputting of the target speech, comprises:
in response to detecting the end in the inputting of speech, obtaining the second input speech from the user before the moment of the end in the inputting of the target speech;
performing a speech recognition on the second input speech to obtain a second text;
obtaining a feature representation of the second input speech using the speech encoder in the speech question answering processing system based on the second input speech and the second text, wherein the length of the feature expression of the second input speech is equal to the length of the second text.

9. The method according to claim 7, wherein detecting the pause in the inputting of the target speech comprises:
detecting that the duration from the moment of the pause in the inputting of the speech reaches a first preset duration;
detecting the stop in the inputting of the target speech comprises:
detecting that the duration from the moment of the stop in the inputting of the speech reaches a second preset duration; where the second preset duration is greater than the first preset duration.

10. A method for training a speech question answering system, comprising:
obtaining training data, the training data comprising a training text question, an annotated text answer, and an annotated feature representation of the training text question;
performing a speech mixing on the training text question using a pre-trained speech mixing system to obtain a training speech question;
adjusting parameters in the speech question answering system based on the training speech question, the training text question, the annotated feature representation of the training text question and the annotated text answer to obtain the trained speech question answering processing system, wherein the speech question answering system is used in the method according to claim 1.

11. The method according to claim 10, wherein adjusting parameters in the speech question answering system based on the training speech question, the training text question, the annotated feature representation of the training text question and the annotated text answer to obtain the trained speech question answering processing system comprises:
obtaining a feature representation of the training speech question based on the training text question using a speech encoder in the speech question answering system, wherein the length of the feature representation is equal to the length of the training text question;
generating a predicted text answer based on the feature representation of the training speech question using the cross attention large language model in the speech question answering system;
adjusting parameters in the speech question answering system based on the feature representation of the training speech question, the annotated feature representation of the training text question, the annotated text answer, and the predicted text answer.

12. The method according to claim 11, wherein adjusting parameters in the speech question answering system based on the feature representation of the training speech question, the annotated feature representation of the training text question, the annotated text answer, and the predicted text answer comprises:
constructing a first loss function based on the feature representation of the training speech question and the annotated feature representation of the training text question;
constructing a second loss function based on the annotated text answer and the predicted text answer;
adjusting parameters of the speech encoder and the cross attention large language model based on the first loss function and the second loss function.

13. The method according to claim 12, wherein adjusting parameters of the speech encoder and the cross attention large language model based on the first loss function and the second loss function comprises:
taking the sum of the first loss function and the second loss function as the integrated loss function;
adjusting the parameters of the speech encoder and the cross-attention large language model so that the integrated loss function converges based on the integrated loss function.

14. An electronic device, comprising:
at least one processor; and
a memory communicatively connected with the at least one processor;
wherein the memory stores instructions executable by the at least one processor, and the instructions are executed by the at least one processor to enable the at least one processor to perform a method for processing cross-modal question answering based on large model, wherein the method for processing cross-modal question answering based on large model comprises:
performing an activity detection on a target speech input by a user;
in response to detecting a pause in the inputting of the target speech, obtaining a first text corresponding to a first input speech before the moment of the pause in the target speech;
performing a text response processing using a pre-trained speech question answering processing system based on the first text and the first input speech.

15. The electronic device according to claim 14, wherein performing the text response processing using the pre-trained speech question answering processing system based on the first text and the first input speech comprises:
obtaining a semantic completeness of the first text using a pre-trained completeness detection model;
performing a text response processing using the speech question answering processing system based on the semantic completeness, the first text and the first input speech.

16. The electronic device according to claim 15, wherein performing the text response processing using the speech question answering processing system based on the semantic completeness, the first text and the first input speech comprises:
obtaining a feature representation of the first input speech by using a speech encoder in the speech question answering processing system based on the first input speech and the first text, wherein the length of the feature representation is equal to the length of the first text;
performing a text response processing using a cross attention large language model in the speech question answering processing system based on the semantic completeness and the feature representation of the first input speech.

17. The electronic device according to claim 16, wherein performing the text response processing using the cross attention large language model in the speech question answering processing system based on the semantic completeness and the feature representation of the first input speech comprises:
in response to determining that the semantic completeness is less than a preset completeness, generating question information based on the feature representation of the first input speech using the cross attention large language model;
performing a text response based on the questioning information.

18. The electronic device according to claim 16, wherein performing the text response processing using the cross attention large language model in the speech question answering processing system based on the semantic completeness and the feature representation of the first input speech comprises:
in response to determining that the semantic completeness is greater than or equal to preset completeness, generating a first text answer based on the feature representation of the first input speech using the cross attention large language model; and performing a text response based on the first text answer.

19. The electronic device according to claim 18, wherein after generating the first text answer based on the feature representation of the first input speech using the cross attention large language model, the method further comprises:
storing the feature representation of the first input speech and the first text answer in a cache.

20. A non-transitory computer readable storage medium with computer instructions stored thereon, wherein the computer instructions are used for causing a method for processing cross-modal question answering based on large model, wherein the method for processing cross-modal question answering based on large model comprises:
performing an activity detection on a target speech input by a user;
in response to detecting a pause in the inputting of the target speech, obtaining a first text corresponding to a first input speech before the moment of the pause in the target speech;
performing a text response processing using a pre-trained speech question answering processing system based on the first text and the first input speech.
